(19) United States
(12) Patent Application Publication
(10) Pub. No.: US 2026/0235822 A1
(43) Pub. Date: Aug. 13, 2026

(54) ELECTRONIC DEVICE

(71) Applicant: Advanced Semiconductor Engineering, Inc., Kaohsiung (TW)

(72) Inventors: Yuh-Shan SU, Kaohsiung (TW); Qin-Ye HUANG, Kaohsiung (TW); Tsung-Tang TSAI, Kaohsiung (TW); Shiuan-Yu LIN, Kaohsiung (TW)

(73) Assignee: Advanced Semiconductor Engineering, Inc., Kaohsiung (TW)

(21) Appl. No.: 19/050,094

(22) Filed: Feb. 10, 2025

(51) Int. Cl. G02B 6/42; G02B 6/43

(52) U.S. Cl. CPC G02B 6/4214; G02B 6/43

(57) ABSTRACT

An electronic device is provided. The electronic device includes a photonic component, a waveguide structure, and a cladding structure. The waveguide structure is configured to optically couple to the photonic component. The cladding structure includes a first portion and a second portion including different materials and covering different regions of the waveguide structure.

### BACKGROUND

### 1. Technical Field

The present disclosure relates generally to an electronic device. Specifically, the present disclosure relates to an electronic device including a waveguide structure.

### 2. Description of the Related Art

As optical communication products continue to evolve towards smaller sizes, the distance between optical fibers and the device is becoming shorter. This evolution has even progressed to the point where optical channels may be integrated in the device. Consequently, the technology for integrating optical channels into the device is becoming increasingly important.

### SUMMARY

In one or more arrangements, an electronic device includes a photonic component, a waveguide structure, and a cladding structure. The waveguide structure is configured to optically couple to the photonic component. The cladding structure includes a first portion and a second portion including different materials and covering different regions of the waveguide structure.

In one or more arrangements, an electronic device includes a first photonic component, a carrier, and an optical waveguide structure. The carrier includes a first conductive layer and a second conductive layer at different elevations and electrically connected to the first photonic component. The optical waveguide structure includes a first waveguide and a second waveguide at different elevations and disposed adjacent to the first conductive layer and the second conductive layer, respectively.

In one or more arrangements, an electronic device includes a photonic component and an optical coupling structure. The optical coupling structure is configured to optically couple to the photonic component. The optical coupling structure includes a first waveguide and a second waveguide at different elevations and extending in non-parallel directions.

### BRIEF DESCRIPTION OF THE DRAWINGS

Aspects of the present disclosure are better understood from the following detailed description when read with the accompanying drawings. It is noted that various features may not be drawn to scale, and the dimensions of the various features may be arbitrarily increased or reduced for clarity of discussion.

FIG. 1 is a top view of an electronic device in accordance with some arrangements of the present disclosure.

FIG. 2A is a cross-section of an electronic device in accordance with some arrangements of the present disclosure.

FIG. 2B is a cross-section of an electronic device in accordance with some arrangements of the present disclosure.

FIG. 2C is a cross-section of an electronic device in accordance with some arrangements of the present disclosure.

FIG. 2D is a cross-section of a portion of an electronic device in accordance with some arrangements of the present disclosure.

FIG. 3A is a cross-section of an electronic device in accordance with some arrangements of the present disclosure.

FIG. 3B is a cross-section of an electronic device in accordance with some arrangements of the present disclosure.

FIG. 4A is a perspective view of a portion of an electronic device in accordance with some arrangements of the present disclosure.

FIG. 4B is a cross-section of an electronic device in accordance with some arrangements of the present disclosure.

FIG. 4C is a perspective view of a portion of an electronic device in accordance with some arrangements of the present disclosure.

FIG. 4D is a cross-section of an electronic device in accordance with some arrangements of the present disclosure.

FIG. 5A, FIG. 5B, FIG. 5C, FIG. 5D, FIG. 5E, and FIG. 5F illustrate various stages of an example of a method for manufacturing an electronic device in accordance with some arrangements of the present disclosure.

FIG. 6A, FIG. 6B, FIG. 6C, FIG. 6D, FIG. 6E, and FIG. 6F illustrate various stages of an example of a method for manufacturing an electronic device in accordance with some arrangements of the present disclosure.

FIG. 7A, FIG. 7B, FIG. 7C, FIG. 7D, FIG. 7E, FIG. 7F, FIG. 7G, and FIG. 7H illustrate various stages of an example of a method for manufacturing an electronic device in accordance with some arrangements of the present disclosure.

Common reference numerals are used throughout the drawings and the detailed description to indicate the same or similar elements. The present disclosure will be more apparent from the following detailed description taken in conjunction with the accompanying drawings.

### DETAILED DESCRIPTION

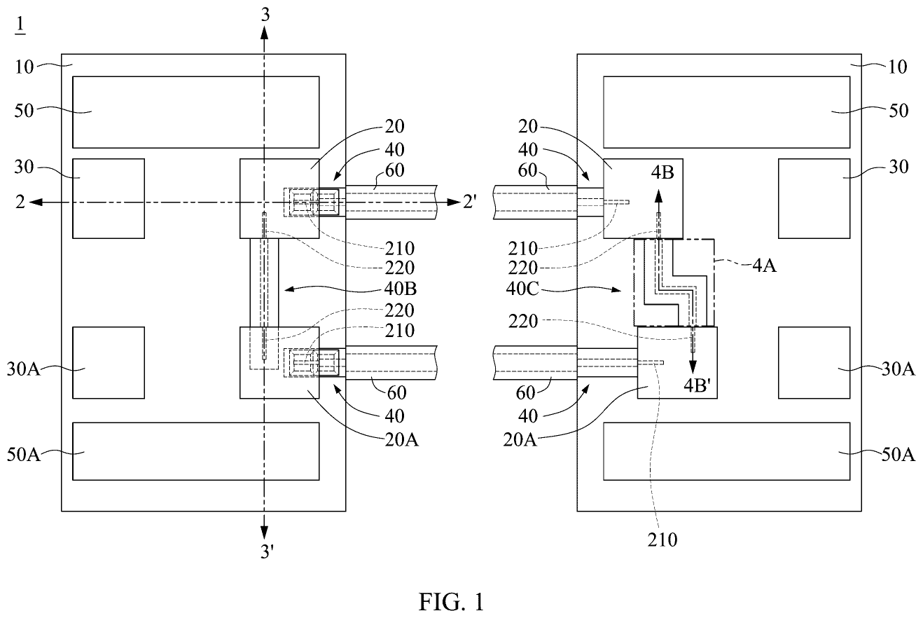

FIG. 1 is a top view of an electronic device 1 in accordance with some arrangements of the present disclosure. The electronic device 1 may include carriers 10, photonic components 20 and 20A, electronic components 30, 30A, 50, and 50A, optical coupling structures 40, 40A, 40B, and 40C, and optical components 60.

The carriers 10 may support the photonic components 20 and 20A, the electronic components 30, 30A, 50, and 50A, and the optical coupling structures 40, 40A, 40B, and 40C. The carrier 10 may include, for example, a printed circuit board, such as a paper-based copper foil laminate, a composite copper foil laminate, or a polymer-impregnated glass-fiber-based copper foil laminate. The carrier 10 may include an interconnection structure, such as a plurality of conductive traces and a plurality of conductive vias. In some embodiments, the carrier 10 includes a substrate, such as a semiconductor substrate, a ceramic substrate, a metal plate, an organic substrate, or a leadframe. In some embodiments, the carrier 10 may include a two-layer substrate which includes a core layer and a conductive material and/or structure disposed on an upper surface and a bottom surface of the carrier 10.

The photonic components 20 and 20A may be disposed over and electrically connected to the carrier 10. The photonic components 20 and 20A may be configured to optically couple to one or more optical components (e.g., the optical component 60). Each of the photonic components 20 and 20A may be or include a photonic integrated circuit (PIC), a laser diode, a receiver, a waveguide, a photodetector, a photodiode, a semiconductor optical amplifier (SOA), a grating coupler, a fiber coupling structure, an optical modulator (e.g., Mach-Zehnder modulator or microring modulator), or a combination thereof. In some arrangements, each of the photonic components 20 and 20A includes waveguides 210 and 220. The waveguides 210 and 220 may be referred to as optical waveguides or optical channels.

The electronic components 30 and 30A may be disposed over and electrically connected to the carrier 10. In some arrangements, the electronic component 30 is electrically connected to the photonic component 20 through the carrier 10, and the electronic component 30A is electrically connected to the photonic component 20A through the carrier 10. Each of the electronic components 30 and 30A may be or include an electronic integrated circuit (EIC). Each of the electronic components 30 and 30A may include a logic circuit. Each of the electronic components 30 and 30A may include a modulator driver (DRV), a trans-impedance amplifier (TIA), or a combination thereof. The photonic component 20 and the electronic component 30 collectively may be or include an optical engine for providing signal transmission for the electronic component 50 through optical communication. The photonic component 20A and the electronic component 30A collectively may be or include an optical engine for providing signal transmission for the electronic component 50 through optical communication.

The optical coupling structures 40, 40A, 40B, and 40C may be integrated into the carriers 10. In some arrangements, the optical coupling structure 40 is integrated into the carrier 10 and configured to optically couple to the photonic component 20. In some arrangements, the optical coupling structure 40 is integrated into the carrier 10 and configured to optically couple the photonic component 20 to the optical component 60. In some arrangements, the optical coupling structure 40A is integrated into the carrier 10 and configured to optically couple to the photonic component 20A. In some arrangements, the optical coupling structure 40A is integrated into the carrier 10 and configured to optically couple the photonic component 20A to the optical component 60. In some arrangements, the optical coupling structure 40B is integrated into the carrier 10 and configured to optically couple the photonic component 20 to the photonic component 20A. In some arrangements, the optical coupling structure 40C is integrated into the carrier 10 and configured to optically couple the photonic component 20 to the photonic component 20A.

The electronic components 50 and 50A may be disposed over and electrically connected to the carriers 10. In some arrangements, the electronic component 50 is electrically connected to the photonic component 20 through the carrier 10, and the electronic component 50A is electrically connected to the photonic component 20A through the carrier 10. Each of the electronic components 50 and 50A may be or include a processing component, e.g., an ASIC, an FPGA, a GPU, or the like, or a combination thereof.

In some arrangements, the electronic component 50 is configured to transmit a command to the electronic component 30, the electronic component 30 is configured to receive the command, generate electrical signals in response to the command, and transmit the electrical signals to the photonic component 20, and the photonic component 20 is configured to convert the electrical signals to optical signals and transmit the optical signals to the optical component 60 through the waveguide 210 or to another photonic component 20A through the waveguide 220. The optical signals may be received by another photonic component (e.g., the photonic component 20A on the same carrier 10 or the photonic component 20 on another carrier 10) and converted to electrical signals to be transmitted to a corresponding electronic component 50 or 50A.

The optical components 60 may be optically coupled to the photonic components 20 and 20A. In some arrangements, each of the photonic components 20 and 20A is configured to optically couple to at least one of the optical components 60. In some arrangements, the optical component 60 includes one or more optical fibers. In some arrangements, the optical component 60 is or includes an optical fiber array unit (FAU).

According to some arrangements of the present disclosure, the optical coupling structure for optically coupling to the photonic component is integrated into the carrier that supports the photonic component. Therefore, the optical transmission path can be reduced, the optical speed can be increased, and the transmission loss can be reduced.

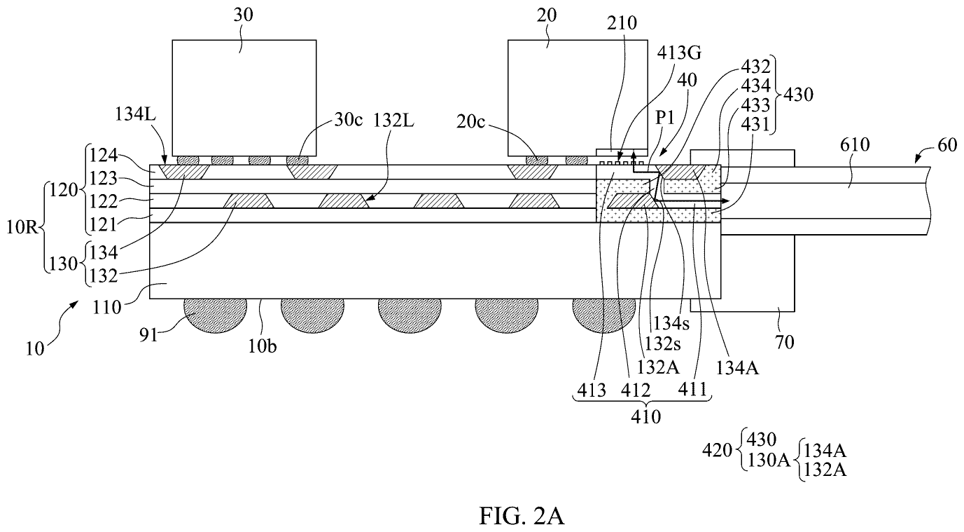

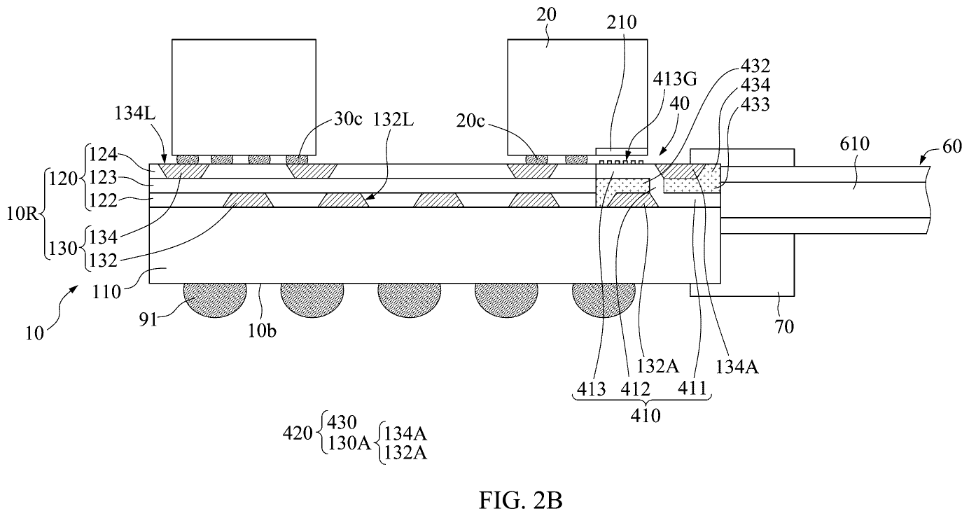

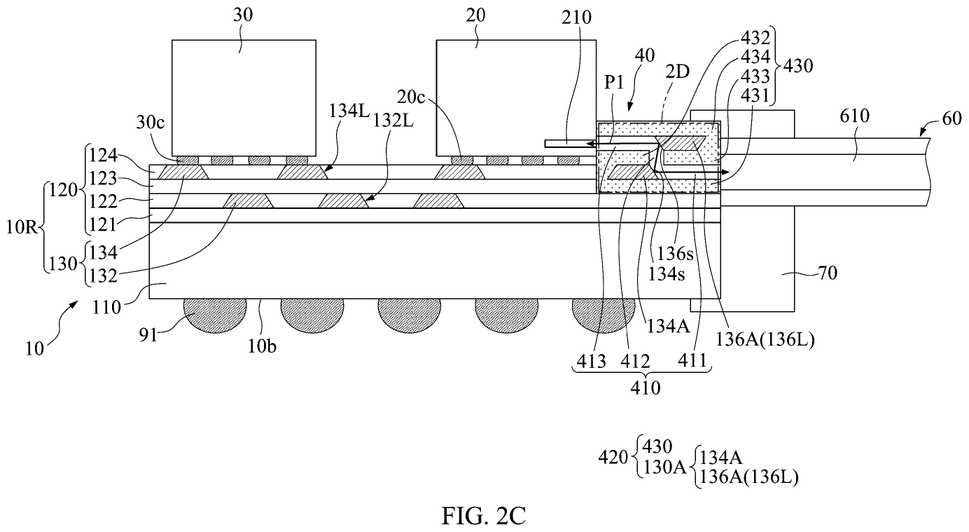

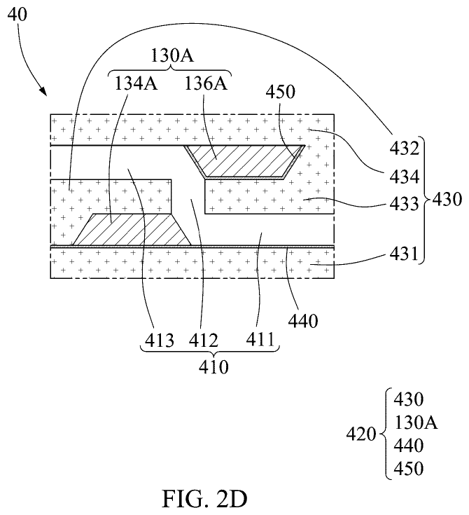

FIG. 2A is a cross-section of an electronic device 1 in accordance with some arrangements of the present disclosure. In some arrangements, FIG. 2A is a cross-section along a line 2-2′ in FIG. 1.

In some arrangements, the electronic device 1 further includes connection elements 20c and 30c and electrical contacts 91. In some arrangements, the connection elements 20c are between the photonic component 20 and the carrier 10. In some arrangements, the connection elements 30c are between the electronic component 30 and the carrier 10. In some arrangements, the electrical contacts 91 are disposed over a lower surface 10b of the carrier 10. The connection elements 20c and 30c may include conductive bumps, solder elements, or the like. The electrical contacts 91 may include controlled collapse chip connection (C4) bumps, a ball grid array (BGA), or a land grid array (LGA).

In some arrangements, the carrier 10 includes a substrate 110, a dielectric structure 120, and conductive layers 132L and 134L. In some arrangements, the electronic component 30 is disposed over the carrier 10 and electrically connected to the conductive layers 132L and 134L. The substrate 110 may be or include a semiconductor substrate, e.g., a silicon substrate. In some arrangements, the substrate 110 supports the conductive layers 132L and 134L. In some arrangements, the dielectric structure 120 includes a plurality of dielectric layers 121, 122, 123, and 124. The dielectric layers 121, 122, 123, and 124 may independently include, for example, one or more organic materials (e.g., phosphoric anhydride (PA), polyimide (PI), polybenzoxazole (PBO), epoxy, and an epoxy-based material) or one or more inorganic materials (e.g., silicon oxide, silicon nitride, glass, and ceramic).

In some arrangements, the conductive layers 132L and 134L are at different elevations and electrically connected to the photonic component 20. In some arrangements, the electronic component 30 is electrically connected to the photonic component 20 through the conductive layers 132L and 132L. In some arrangements, the conductive layers 132L and 134L are at different elevations and electrically connected to the electronic component 30. In some arrangements, the conductive layers 132L and 134L are at least partially within the dielectric structure 120. In some arrangements, the conductive layer 132L includes conductive traces 132 in the dielectric layer 122 and at least a conductive trace 132A separated from the dielectric layer 122. In some arrangements, one or more of the conductive traces 132 are electrically connected to the photonic component 20 and/or the electronic component 30. In some arrangements, the conductive layer 134L includes conductive traces 134 in the dielectric layer 124 and at least a conductive trace 134A separated from the dielectric layer 124. In some arrangements, one or more of the conductive traces 134 are electrically connected to the photonic component 20 and/or the electronic component 30. In some arrangements, one or more of the conductive traces 134 are electrically connected to the photonic component 20 through the connection elements 20c. In some arrangements, one or more of the conductive traces 134 are electrically connected to the electronic component 30 through the connection elements 30c. The conductive layers 132L and 134L may include one or more conductive materials such as a metal material or a metal alloy. Examples include gold (Au), silver (Ag), aluminum (Al), copper (Cu), or an alloy thereof.

In some arrangements, the conductive traces 132 and 134 collectively construct a conductive structure 130 within the dielectric structure 120, and the dielectric structure 120 and the conductive structure 130 collectively construct an interconnection structure 10R of the carrier 10. In some arrangements, the electronic component 30 is electrically connected to the photonic component 20 through the conductive traces 132 and 134 (or the conductive structure 130). The interconnection structure 10R may be referred to as an electrical interconnection structure. The interconnection structure may electrically connect the electronic component 30 to the electrical contacts 91 to further electrically connect to external components.

In some arrangements, the optical coupling structure 40 is integrated into the carrier 10. In some arrangements, the optical coupling structure 40 is integrated with the interconnection structure 10R. In some arrangements, the optical coupling structure 40 and the interconnection structure 10R (or the electrical interconnection structure) collectively construct a redistribution structure of the electronic device 1.

In some arrangements, the optical coupling structure 40 includes a waveguide structure 410 and a cladding structure 420. In some arrangements, the cladding structure 420 covers or encapsulates the waveguide structure 410 to allow lights or optical signals to transmit within the waveguide structure 410. In some arrangements, the cladding structure 420 contacts the dielectric structure 120.

In some arrangements, the waveguide structure 410 is configured to optically couple to the photonic component 20. In some arrangements, the waveguide structure 410 is configured to optically couple the photonic component 20 to the optical component 60. In some arrangements, the optical component 60 includes one or more optical fibers 610 and is fastened or fixed to the carrier 10 through a fixing element 70. In some arrangements, the optical component 60 is or includes an optical fiber array unit (FAU). In some arrangements, the waveguide structure 410 is configured to optically couple the waveguide 210 of the photonic component 20 to the optical fiber 610 of the optical component 60.

In some arrangements, the waveguide structure 410 includes a plurality of waveguides 411, 412, and 413. In some arrangements, the waveguides 411, 412, and 413 are at different elevations. In some arrangements, the waveguide 411 is disposed adjacent to the conductive layer 132L. In some arrangements, the waveguide 411 and the conductive layer 132L are at the same elevation. In some arrangements, the waveguide 413 is disposed adjacent to the conductive layer 134L. In some arrangements, the waveguide 413 and the conductive layer 134L are at the same elevation. In some arrangements, the waveguides 411 and 413 contact one or more conductive traces of the conductive layers of the carrier 10. In some arrangements, the waveguide 412 is disposed between and optically coupling to the waveguide 411 and the waveguide 413. In some arrangements, the waveguides 411, 412, and 413 may be referred to as optical channels. The waveguides 411 and 413 may be or include optical coupling layers, and the waveguide 412 may be or include an optical coupling via (or an optical via). In some arrangements, the waveguides 411, 412, and 413 include one or more polymer materials (e.g., one or more photoresist materials).

In some arrangements, the cladding structure 420 includes at least a first portion and a second portion including different materials and covering different regions of the waveguide structure 410. In some arrangements, the cladding structure 420 includes a reflective structure 130A (or the first portion) and a cladding layer 430 (or the second portion). In some arrangements, the reflective structure 130A and the cladding layer 430 include different materials and cover different regions of the waveguide structure 410. In some arrangements, the reflective structure 130A and the cladding layer 430 contact different regions of the waveguide structure 410.

In some arrangements, the reflective structure 130A (or the first portion) of the cladding structure 420 includes a plurality of conductive traces (e.g., the conductive traces 132A and 134A) disposed at different elevations. The conductive traces (e.g., the conductive traces 132A and 134A) of the reflective structure 130A may be referred to as reflective elements. In some arrangements, the conductive trace 132A contacts the waveguide 411, and the conductive trace 134A contacts the waveguide 413. In some arrangements, the conductive trace 132A and the conductive trace 134A taper toward opposite directions. In some arrangements, the conductive trace 132A defines a slope (or a chamfered surface) of the waveguide 411, and the conductive trace 134A defines a slope (or a chamfered surface) of the waveguide 413. In some arrangements, the conductive trace 132A (or the reflective element) contacts the chamfered surface of the waveguide 411, and the conductive trace 134A (or the reflective element) contacts the chamfered surface of the waveguide 413. In some arrangements, the conductive trace 132A defines a reflective surface of the waveguide 411, and the conductive trace 134A defines a reflective surface of the waveguide 413. In some arrangements, the conductive trace 132A has an inclined surface 132s (e.g., the reflective surface) contacting the waveguide 411, and the conductive trace 134A has an inclined surface 134s (e.g., the reflective surface) contacting the waveguide 413. In some arrangements, the reflective structure 130A (or the first portion) includes a metal material.

In some arrangements, an optical path P1 for optical transmission between the photonic component 20 and the optical component 60 may pass the waveguide structure 410, and the propagating direction of the optical path P1 may be switched by the reflective surfaces of the reflective structure 130A (or the first portion) of the cladding structure 420.

In some arrangements, the conductive traces 132 and the conductive trace 132A taper toward a substantially same direction. In some arrangements, the conductive traces 134 and the conductive trace 134A taper toward a substantially same direction. In some arrangements, the conductive traces 132 and the conductive trace 132A taper toward a first direction, and the conductive traces 134 and the conductive trace 134A taper toward a second direction opposite to the first direction. In some arrangements, the conductive traces 132 and the conductive trace 132A are at a first elevation, and the conductive traces 134 and the conductive trace 134A are at a second elevation higher than the first elevation with respect to a bottom surface (e.g., the lower surface 10b) of the carrier 10. In some arrangements, the waveguide 411, the conductive traces 132, and the conductive trace 132A are at the same elevation (e.g., the first elevation). In some arrangements, the waveguide 413, the conductive traces 134, and the conductive trace 134A are at the same elevation (e.g., the second elevation).

In some arrangements, the cladding layer 430 (or the second portion) of the cladding structure 420 covers the waveguide structure 410. In some arrangements, the cladding layer 430 contacts the waveguides 411, 412, and 413. In some arrangements, the cladding layer 430 includes cladding sub-layers 431, 432, 433, and 434. In some arrangements, the cladding layer 430 includes a dielectric material. The cladding layer 430 may be referred to as a dielectric layer. The cladding layer 430 and the dielectric structure 120 may include the same or different materials. In some arrangements, the cladding layer 430 includes a polymer material (e.g., a photoresist material), and the dielectric structure 120 includes an inorganic dielectric material.

In some arrangements, the photonic component 20 is disposed over and at least partially vertically overlapping the waveguide structure 410. In some arrangements, the waveguide structure 410 further includes a grating coupler 413G disposed over the waveguides 411 and 413 and configured to optically couple to the photonic component 20. The grating coupler 413G and the waveguide 413 may be formed integrally as a monolithic structure. In some arrangements, the grating coupler 413G of the waveguide structure 410 is optically coupled to the waveguide 210 of the photonic component 20.

In some arrangements, the waveguide 411 contacts the waveguide 412, the conductive trace 132A, and the cladding layer 430. In some arrangements, the waveguide 412 contacts the waveguide 411 and the cladding layer 430. In some arrangements, the waveguide 413 contacts the grating coupler 413G, the waveguide 412, the conductive trace 134A, and the cladding layer 430.

According to some arrangements of the present disclosure, the optical coupling structure 40 is integrated with the interconnection structure 10R. Therefore, the manufacturing processes for the optical coupling structure 40 and the interconnection structure 10R can be integrated. The process can be simplified, and the cost can be reduced.

In addition, according to some arrangements of the present disclosure, the optical coupling structure 40 and the interconnection structure 10R collectively construct a redistribution structure of the electronic device 1. Therefore, the optical coupling structure 40 is fitted into a space of the redistribution structure of the electronic device 1, and thus the overall volume occupied by the optical coupling structure 40 and the interconnection structure 10R can be reduced, which is advantageous to reducing the size of the electronic device 1.

Moreover, according to some arrangements of the present disclosure, the waveguide structure 410 includes a plurality of waveguides 411, 412, and 413 at different elevations that optically couple to one another. Therefore, optical signals can be transmitted both horizontally and vertically. As such, the design of the optical transmission path can be more flexible according to actual applications.

FIG. 2B is a cross-section of an electronic device 1 in accordance with some arrangements of the present disclosure. In some arrangements, FIG. 2B is a cross-section along a line 2-2′ in FIG. 1. The structure shown in FIG. 2B is similar to the structure shown in FIG. 2A, and the differences therebetween are described as follows.

In some arrangements, the dielectric structure 120 includes dielectric layers 122, 123, and 124. In some arrangements, the substrate 110 supports the conductive layers 132L and 134L. In some arrangements, the waveguide 411 contacts the substrate 110, the conductive trace 132A, and the cladding layer 430. In some arrangements, the substrate 110 contacts the conductive traces 132 and 132A.

FIG. 2C is a cross-section of an electronic device 1 in accordance with some arrangements of the present disclosure. In some arrangements, FIG. 2C is a cross-section along a line 2-2′ in FIG. 1. The structure shown in FIG. 2C is similar to the structure shown in FIG. 2A, and the differences therebetween are described as follows.

In some arrangements, the carrier 10 further includes a conductive layer 136L. In some arrangements, the conductive layers 132L, 134L, and 136L are at different elevations. In some arrangements, the conductive layer 132L includes conductive traces 132 in the dielectric layer 122. In some arrangements, the conductive layer 134L includes conductive traces 134 in the dielectric layer 124 and at least a conductive trace 134A separated from the dielectric layer 124. In some arrangements, the conductive layer 136L includes at least a conductive trace 136A. The conductive layers 136L may include one or more conductive materials such as a metal material or a metal alloy. Examples include Au, Ag, Al, Cu, or an alloy thereof.

In some arrangements, the reflective structure 130A (or the first portion) of the cladding structure 420 includes a plurality of conductive traces (e.g., the conductive traces 134A and 136A) disposed at different elevations. The conductive traces (e.g., the conductive traces 134A and 136A) of the reflective structure 130A may be referred to as reflective elements. In some arrangements, the conductive trace 134A contacts the waveguide 411, and the conductive trace 136A contacts the waveguide 413. In some arrangements, the conductive trace 134A and the conductive trace 136A taper toward opposite directions. In some arrangements, the conductive trace 134A defines a slope (or a chamfered surface) of the waveguide 411, and the conductive trace 136A defines a slope (or a chamfered surface) of the waveguide 413. In some arrangements, the conductive trace 134A (or the reflective element) contacts the chamfered surface of the waveguide 411, and the conductive trace 136A (or the reflective element) contacts the chamfered surface of the waveguide 413. In some arrangements, the conductive trace 134A defines a reflective surface of the waveguide 411, and the conductive trace 136A defines a reflective surface of the waveguide 413. In some arrangements, the conductive trace 134A has an inclined surface 134s (e.g., the reflective surface) contacting the waveguide 411, and the conductive trace 136A has an inclined surface 136s (e.g., the reflective surface) contacting the waveguide 413.

In some arrangements, the waveguide 411, the conductive traces 134, and the conductive trace 134A are at the same elevation (e.g., the first elevation). In some arrangements, the waveguide 413 and the conductive trace 136A are at the same elevation (e.g., the second elevation).

In some arrangements, the photonic component 20 is disposed next to and free from vertically overlapping the waveguide structure 410. In some arrangements, the waveguide 413 of the waveguide structure 410 is optically coupled to the waveguide 210 of the photonic component 20 by edge coupling.

In some arrangements, the waveguide 411 contacts the waveguide 412, the conductive trace 134A, and the cladding layer 430. In some arrangements, the waveguide 412 contacts the waveguide 412, the conductive trace 136A, and the cladding layer 430.

FIG. 2D is a cross-section of a portion of an electronic device 1 in accordance with some arrangements of the present disclosure. In some arrangements, FIG. 2D is a cross-section of a portion 2D in FIG. 2C.

In some arrangements, the cladding structure 420 further comprises seed layers 440 and 450. In some arrangements, the seed layers 440 and 450 include a material different from materials of the conductive traces 132A, 134A, and 136A. In some arrangements, the seed layers 440 and 450 contact the waveguide structure 410. In some arrangements, the seed layer 440 contacts the conductive trace 134A and the cladding sub-layers 431 and 432 of the cladding layer 430. In some arrangements, the seed layer 450 contacts the conductive trace 136A and the cladding sub-layers 433 and 434 of the cladding layer 430. In some arrangements, the waveguide 411 contacts the seed layer 440. In some arrangements, the waveguide 413 contacts the seed layer 450.

In some arrangements, referring to FIG. 1, the optical coupling structure 40A includes a structure similar to that of the optical coupling structure 40 as illustrated in FIGS. 2A-2D, and the description thereof is omitted herein.

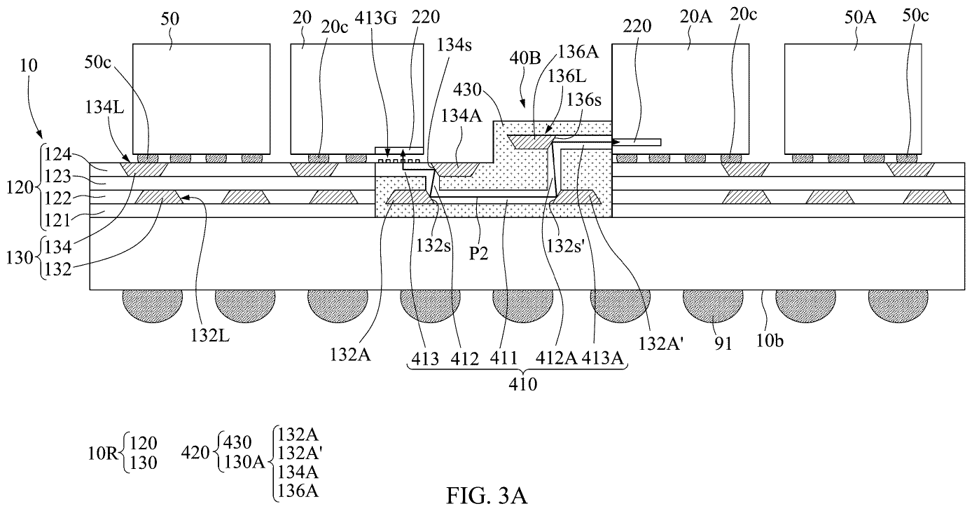

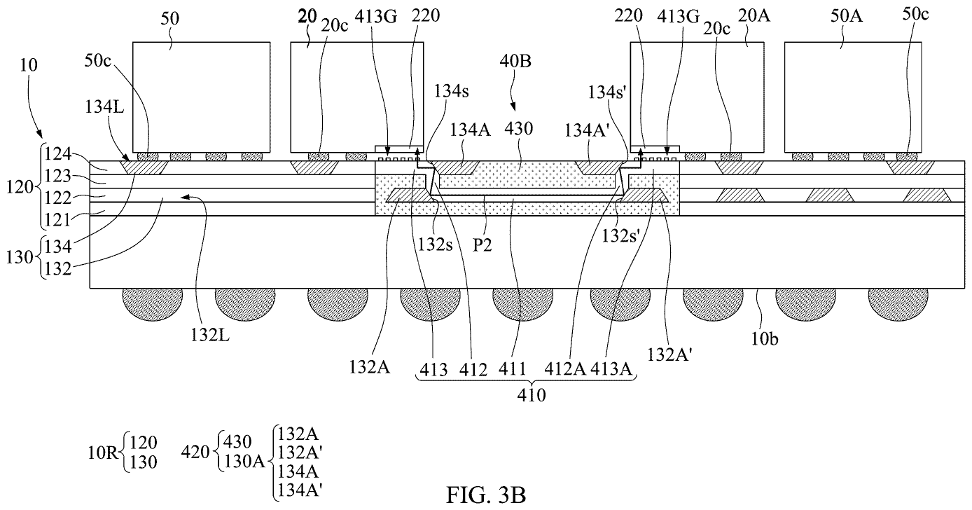

FIG. 3A is a cross-section of an electronic device 1 in accordance with some arrangements of the present disclosure. In some arrangements, FIG. 3A is a cross-section along a line 3-3′ in FIG. 1.

In some arrangements, the photonic component 20A is configured to optically couple to the photonic component 20 through the optical coupling structure 40B. In some arrangements, the waveguide 220 of the photonic component 20A is configured to optically couple to the waveguide 220 of the photonic component 20 through the waveguide structure 410.

In some arrangements, the optical coupling structure 40B is integrated into the carrier 10. In some arrangements, the optical coupling structure 40B is integrated with the interconnection structure 10R. In some arrangements, the optical coupling structure 40B includes a waveguide structure 410 and a cladding structure 420. In some arrangements, the cladding structure 420 includes a reflective structure 130A (or the first portion) and a cladding layer 430 (or the second portion).

In some arrangements, the waveguide structure 410 includes a plurality of waveguides 411, 412, 412A, 413, and 413A. In some arrangements, the waveguides 411, 412, 412A, 413, and 413A are at different elevations. In some arrangements, the waveguide 411 is disposed adjacent to the conductive layer 132L. In some arrangements, the waveguide 411 and the conductive layer 132L are at the same elevation. In some arrangements, the waveguide 413 is disposed adjacent to the conductive layer 134L. In some arrangements, the waveguide 413 and the conductive layer 134L are at the same elevation. In some arrangements, the waveguide 413A is disposed adjacent to the conductive layer 136L. In some arrangements, the waveguide 413A and the conductive layer 136L are at the same elevation. In some arrangements, the waveguides 411, 412, 412A, 413, and 413A may be referred to as optical channels. The waveguides 411, 413, and 413A may be or include optical coupling layers, and the waveguides 412 and 412A may be or include optical coupling vias (or optical vias).

In some arrangements, the reflective structure 130A (or the first portion) of the cladding structure 420 includes a plurality of conductive traces (e.g., the conductive traces 132A, 132A′, 134A, and 136A) disposed at different elevations. The conductive traces (e.g., the conductive traces 132A, 132A′, 134A, and 136A) of the reflective structure 130A may be referred to as reflective elements. In some arrangements, the conductive traces 132A and 132A′ contact the waveguide 411, the conductive trace 134A contacts the waveguide 413, and the conductive trace 136A contacts the waveguide 413A.

In some arrangements, the conductive trace 132A defines a slope (or a chamfered surface) of the waveguide 411, the conductive trace 132A′ defines another slope (or another chamfered surface) of the waveguide 411, the conductive trace 134A defines a slope (or a chamfered surface) of the waveguide 413, and the conductive trace 136A defines a slope (or a chamfered surface) of the waveguide 413A. In some arrangements, the conductive trace 132A (or the reflective element) contacts the chamfered surface of the waveguide 411, the conductive trace 132A′ (or the reflective element) contacts another chamfered surface of the waveguide 411, the conductive trace 134A (or the reflective element) contacts the chamfered surface of the waveguide 413, and the conductive trace 136A (or the reflective element) contacts the chamfered surface of the waveguide 413A. In some arrangements, the conductive trace 132A defines a reflective surface of the waveguide 411, the conductive trace 132A′ defines another reflective surface of the waveguide 411, the conductive trace 134A defines a reflective surface of the waveguide 413, and the conductive trace 136A defines a reflective surface of the waveguide 413A. In some arrangements, the conductive trace 132A has an inclined surface 132s (e.g., the reflective surface) contacting the waveguide 411, the conductive trace 132A′ has an inclined surface 132s′ (e.g., the reflective surface) contacting the waveguide 411, the conductive trace 134A has an inclined surface 134s (e.g., the reflective surface) contacting the waveguide 413, and the conductive trace 136A has an inclined surface 136s (e.g., the reflective surface) contacting the waveguide 413A.

In some arrangements, an optical path P2 for optical transmission between the photonic component 20 and the photonic component 20A may pass the waveguide structure 410, and the propagating direction of the optical path P2 may be switched by the reflective surfaces of the reflective structure 130A (or the first portion) of the cladding structure 420.

In some arrangements, the waveguide 411, the conductive traces 132, and the conductive traces 132A and 132A′ are at the same elevation (e.g., a first elevation). In some arrangements, the waveguide 413, the conductive traces 134, and the conductive trace 134A are at the same elevation (e.g., a second elevation higher than the first elevation). In some arrangements, the waveguide 413A and the conductive trace 136A are at the same elevation (e.g., a third elevation higher than the first elevation and the second elevation).

In some arrangements, the waveguide structure 410 further includes a grating coupler 413G disposed over the waveguide 413 and configured to optically couple to the waveguide 220 of the photonic component 20. In some arrangements, the photonic component 20A is disposed next to and free from vertically overlapping the waveguide structure 410. In some arrangements, the waveguide 413A of the waveguide structure 410 is optically coupled to the waveguide 220 of the photonic component 20A by edge coupling.

FIG. 3B is a cross-section of an electronic device 1 in accordance with some arrangements of the present disclosure. In some arrangements, FIG. 3B is a cross-section along a line 3-3′ in FIG. 1. The structure shown in FIG. 3B is similar to the structure shown in FIG. 3A, and the differences therebetween are described as follows.

In some arrangements, the waveguide structure 410 includes a plurality of waveguides 411, 412, 412A, 413, and 413A. In some arrangements, the waveguides 411, 412, 412A, 413, and 413A are at different elevations. In some arrangements, the waveguide 411 is disposed adjacent to the conductive layer 132L. In some arrangements, the waveguide 411 and the conductive layer 132L are at the same elevation. In some arrangements, the waveguides 413 and 413A are disposed adjacent to the conductive layer 134L. In some arrangements, the waveguides 413 and 413A and the conductive layer 134L are at the same elevation. In some arrangements, the waveguides 411, 412, 412A, 413, and 413A may be referred to as optical channels. The waveguides 411, 413, and 413A may be or include optical coupling layers, and the waveguides 412 and 412A may be or include optical coupling vias (or optical vias).

In some arrangements, the waveguide structure 410 further includes grating couplers 413G disposed over the waveguides 413 and 413A and configured to optically couple to the waveguides 220 of the photonic components 20 and 20A.

In some arrangements, the reflective structure 130A (or the first portion) of the cladding structure 420 includes a plurality of conductive traces (e.g., the conductive traces 132A, 132A′, 134A, and 134A′) disposed at different elevations. The conductive traces (e.g., the conductive traces 132A, 132A′, 134A, and 134A′) of the reflective structure 130A may be referred to as reflective elements. In some arrangements, the conductive traces 132A and 132A′ contact the waveguide 411, the conductive trace 134A contacts the waveguide 413, and the conductive trace 134A′ contacts the waveguide 413A.

In some arrangements, the conductive trace 132A defines a slope (or a chamfered surface) of the waveguide 411, the conductive trace 132A′ defines another slope (or another chamfered surface) of the waveguide 411, the conductive trace 134A defines a slope (or a chamfered surface) of the waveguide 413, and the conductive trace 134A′ defines a slope (or a chamfered surface) of the waveguide 413A. In some arrangements, the conductive trace 132A (or the reflective element) contacts the chamfered surface of the waveguide 411, the conductive trace 132A′ (or the reflective element) contacts another chamfered surface of the waveguide 411, the conductive trace 134A (or the reflective element) contacts the chamfered surface of the waveguide 413, and the conductive trace 134A′ (or the reflective element) contacts the chamfered surface of the waveguide 413A. In some arrangements, the conductive trace 132A defines a reflective surface of the waveguide 411, the conductive trace 132A′ defines another reflective surface of the waveguide 411, the conductive trace 134A defines a reflective surface of the waveguide 413, and the conductive trace 134A′ defines a reflective surface of the waveguide 413A. In some arrangements, the conductive trace 132A has an inclined surface 132s (e.g., the reflective surface) contacting the waveguide 411, the conductive trace 132A′ has an inclined surface 132s′ (e.g., the reflective surface) contacting the waveguide 411, the conductive trace 134A has an inclined surface 134s (e.g., the reflective surface) contacting the waveguide 413, and the conductive trace 134A′ has an inclined surface 134s′ (e.g., the reflective surface) contacting the waveguide 413A.

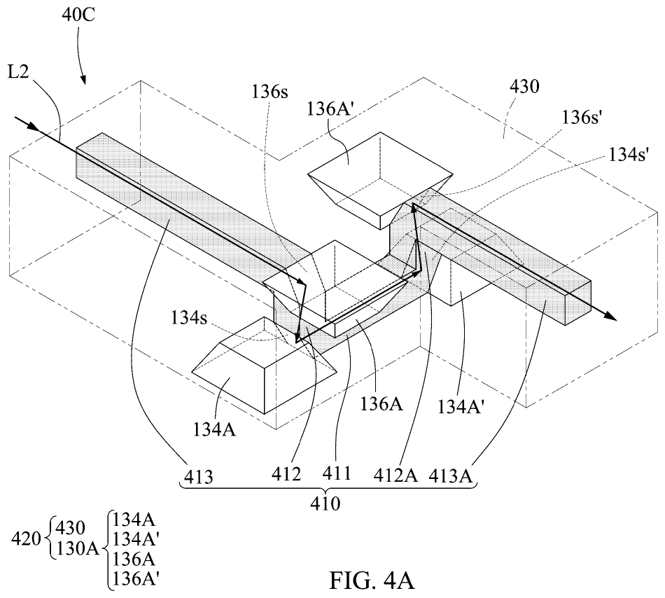

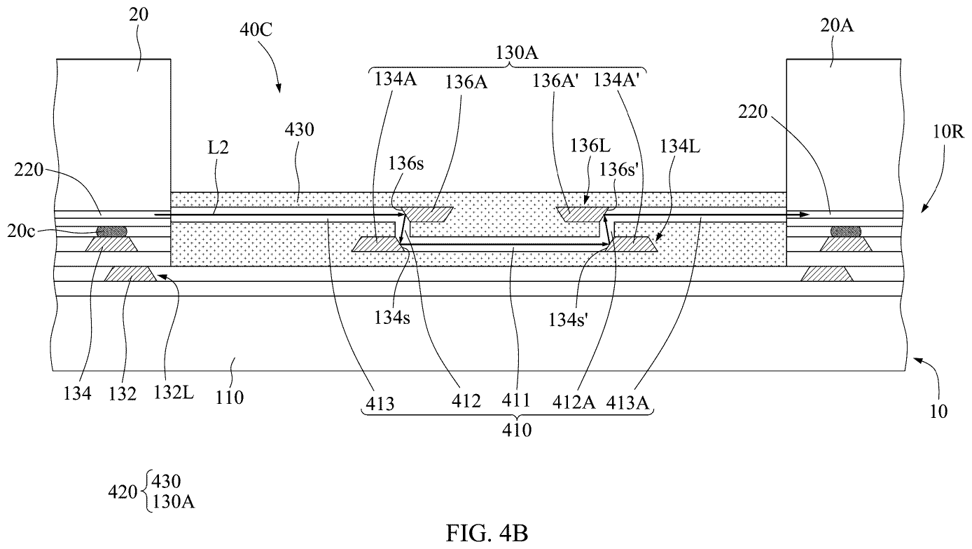

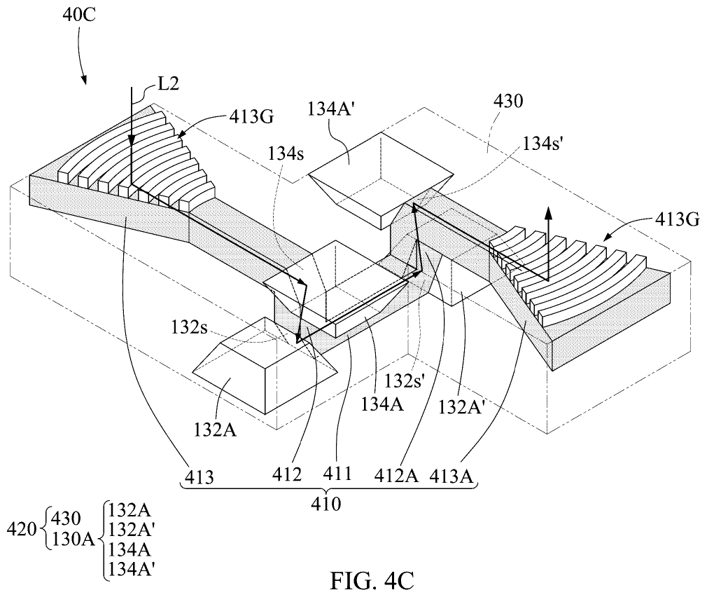

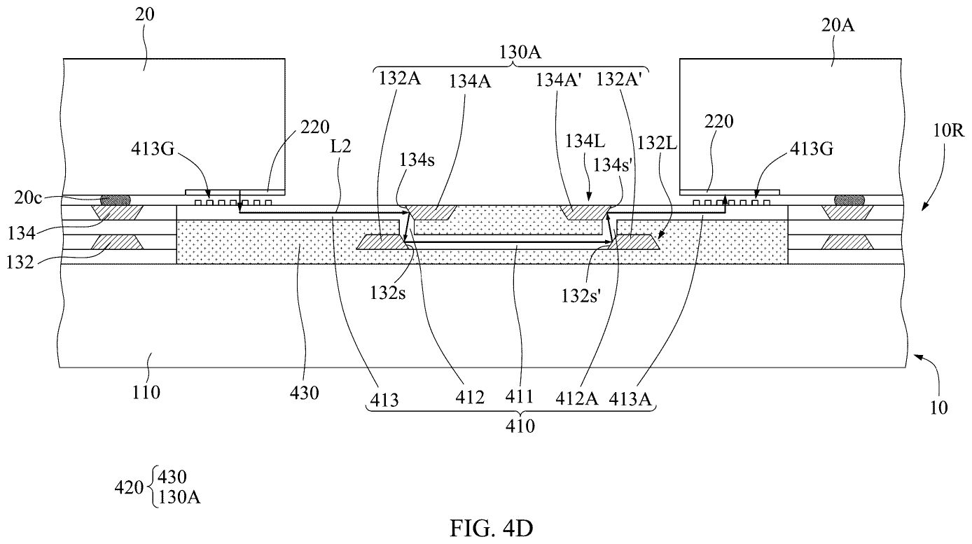

FIG. 4A is a perspective view of a portion of an electronic device 1 in accordance with some arrangements of the present disclosure. FIG. 4B is a cross-section of an electronic device 1 in accordance with some arrangements of the present disclosure. In some arrangements, FIG. 4A is a perspective view of a portion 4A of the electronic device 1 in FIG. 1, and FIG. 4B is a cross-section along a line 4B-4B′ in FIG. 1.

In some arrangements, the waveguide structure 410 of the optical coupling structure 40C includes a plurality of waveguides 411, 412, 412A, 413, and 413A. In some arrangements, the waveguide 411 and the waveguide 413 are at different elevations and extend in non-parallel directions. In some arrangements, the waveguide 411 and the waveguide 413 extend in substantially perpendicular directions. In some arrangements, the waveguide 412 (or the optical via) is between and connecting to the waveguide 411 and the waveguide 413. In some arrangements, the waveguide 413A is configured to optically couple to the waveguide 413 through the waveguide 411. In some arrangements, the waveguide 413A and the waveguide 411 are at different elevations and extending in non-parallel directions. In some arrangements, the waveguide 411 and the waveguide 413A extend in substantially perpendicular directions. In some arrangements, the waveguide 412A (or the optical via) is between and connecting to the waveguide 411 and the waveguide 413A.

In some arrangements, the cladding structure 420 of the optical coupling structure 40C includes at least a first portion and a second portion including different materials and covering different regions of the waveguide structure 410. In some arrangements, the cladding structure 420 covers the waveguides 411, 412, 412A, 413, and 413A. In some arrangements, the cladding structure 420 includes a reflective structure 130A (or the first portion) and a cladding layer 430 (or the second portion).

In some arrangements, the reflective structure 130A includes a plurality of conductive traces (e.g., the conductive traces 134A, 134A′, 136A, and 136A′) disposed at different elevations. The conductive traces (e.g., the conductive traces 134A, 134A′, 136A, and 136A′) of the reflective structure 130A may be referred to as reflective elements. In some arrangements, the optical coupling structure 40C is configured to transmit an optical signal L2 along the waveguides 413, 412, 411, 412A, and 413A, and the propagating direction of the optical signal L2 may be switched by the reflective surfaces of the conductive traces 134A, 134A′, 136A, and 136A′.

FIG. 4C is a perspective view of a portion of an electronic device 1 in accordance with some arrangements of the present disclosure. FIG. 4D is a cross-section of an electronic device 1 in accordance with some arrangements of the present disclosure. In some arrangements, FIG. 4C is a perspective view of a portion 4A of the electronic device 1 in FIG. 1, and FIG. 4D is a cross-section along a line 4B-4B′ in FIG. 1. The structure shown in FIG. 4C is similar to the structure shown in FIG. 4A, the structure shown in FIG. 4D is similar to the structure shown in FIG. 4B, and the differences therebetween are described as follows.

In some arrangements, the waveguide structure 410 of the optical coupling structure 40C includes a plurality of waveguides 411, 412, 412A, 413, and 413A. In some arrangements, the waveguide 411 and the waveguide 413 are at different elevations and extend in non-parallel directions. In some arrangements, the waveguide 411 and the waveguide 413 extend in substantially perpendicular directions. In some arrangements, the waveguide 412 (or the optical via) is between and connecting to the waveguide 411 and the waveguide 413. In some arrangements, the waveguide 413A is configured to optically couple to the waveguide 413 through the waveguide 411. In some arrangements, the waveguide 413A and the waveguide 411 are at different elevations and extending in non-parallel directions. In some arrangements, the waveguide 411 and the waveguide 413A extend in substantially perpendicular directions. In some arrangements, the waveguide 412A (or the optical via) is between and connecting to the waveguide 411 and the waveguide 413A.

In some arrangements, the cladding structure 420 of the optical coupling structure 40C includes at least a first portion and a second portion including different materials and covering different regions of the waveguide structure 410. In some arrangements, the cladding structure 420 covers the waveguides 411, 412, 412A, 413, and 413A. In some arrangements, the cladding structure 420 includes a reflective structure 130A (or the first portion) and a cladding layer 430 (or the second portion).

In some arrangements, the reflective structure 130A includes a plurality of conductive traces (e.g., the conductive traces 132A, 132A′, 134A, and 134A′) disposed at different elevations. The conductive traces (e.g., the conductive traces 132A, 132A′, 134A, and 134A′) of the reflective structure 130A may be referred to as reflective elements. In some arrangements, the optical coupling structure 40C is configured to transmit an optical signal L2 along the waveguides 413, 412, 411, 412A, and 413A, and the propagating direction of the optical signal L2 may be switched by the reflective surfaces of the conductive traces 132A, 132A′, 134A, and 134A′.

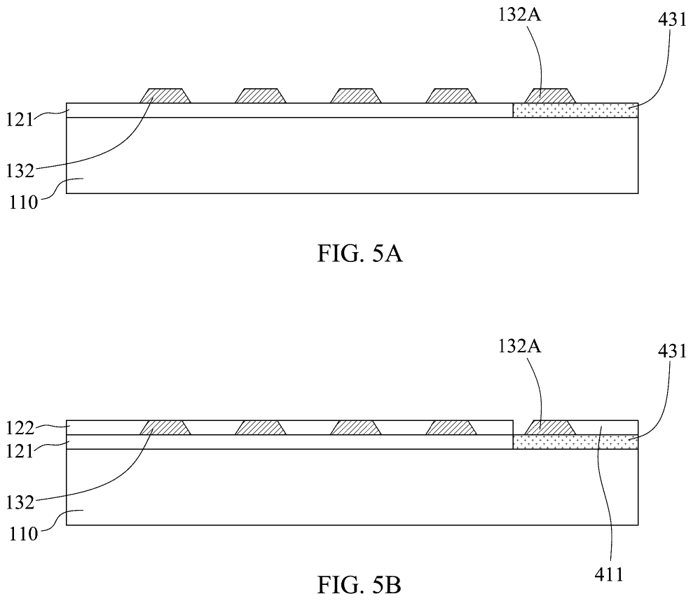

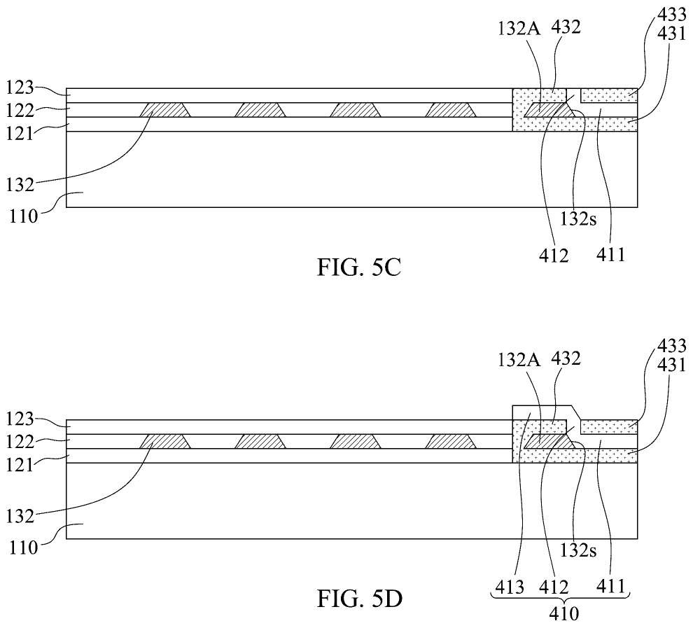

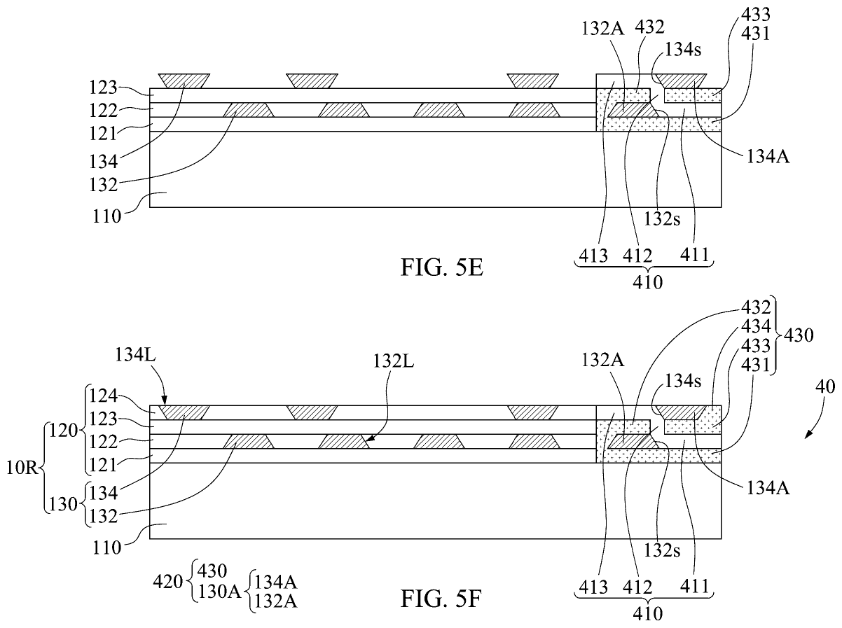

FIG. 5A, FIG. 5B, FIG. 5C, FIG. 5D, FIG. 5E, and FIG. 5F illustrate various stages of an example of a method for manufacturing an electronic device 1 in accordance with some arrangements of the present disclosure.

Referring to FIG. 5A, a substrate 110 may be provided, a dielectric layer 121 and a cladding sub-layer 431 may be formed on the substrate 110, and conductive traces 132 and 132A may be formed on the dielectric layer 121 and the cladding sub-layer 431, respectively. In some arrangements, the cladding sub-layer 431 includes a photoresist material and is formed on the substrate 110, and the dielectric layer 121 is formed on a portion of the substrate 110 exposed by the cladding sub-layer 431. In some arrangements, the cladding sub-layer 431 is formed by coating a photoresist layer on the substrate 110 and removing a portion of the photoresist layer by photolithography. In some arrangements, the conductive traces 132 and 132A are formed by forming a conductive layer and patterning the conductive layer to form the conductive traces 132 and 132A in one patterning operation (e.g., an etching operation to remove portions of the conductive layer). The conductive layer may be formed by deposition, plating, or any suitable operation.

Referring to FIG. 5B, a dielectric layer 122 may be formed on the dielectric layer 121, and a waveguide 411 may be formed on a portion of the cladding sub-layer 431. In some arrangements, the waveguide 411 is formed by coating a photoresist layer on the substrate 110 and removing a portion of the photoresist layer by photolithography. In some arrangements, the dielectric layer 122 is formed by deposition, lamination, or any suitable operation. In some arrangements, the cladding sub-layer 431, the conductive trace 132A, and the waveguide 411 may be covered by a sacrificial layer (e.g., a photoresist layer), a dielectric material layer may be deposited over the dielectric layer 121 and the sacrificial layer, and then the sacrificial layer with a portion of the dielectric material layer may be removed to form the dielectric layer 122 and to form a recess exposing a portion of the cladding sub-layer 431.

Referring to FIG. 5C, a dielectric layer 123 may be formed on the dielectric layer 122, a waveguide 412 may be formed on a portion of the waveguide 411, and cladding sub-layers 432 and 433 may be formed to fill recesses next to the waveguide 412 and the dielectric layer 123. In some arrangements, the dielectric layer 123 is formed by deposition, lamination, or any suitable operation. In some arrangements, the waveguide 412 is formed by coating a photoresist layer on the waveguide 411 and removing a portion of the photoresist layer by photolithography. In some arrangements, the cladding sub-layers 432 and 433 include one or more photoresist materials.

Referring to FIG. 5D, a waveguide 413 may be formed on the cladding sub-layer 432 and the waveguide 412. In some arrangements, the waveguide 413 is formed by coating a photoresist layer on the waveguide 412 and the cladding sub-layers 432 and 433 and removing a portion of the photoresist layer by photolithography.

Referring to FIG. 5E, conductive traces 134 and 134A may be formed on the dielectric layer 123 and the cladding sub-layer 433, respectively. In some arrangements, the conductive traces 134 and 134A are formed by forming a conductive layer and patterning the conductive layer to form the conductive traces 134 and 134A in one patterning operation (e.g., an etching operation to remove portions of the conductive layer). The conductive layer may be formed by deposition, plating, or any suitable operation.

Referring to FIG. 5F, a dielectric layer 124 may be formed on the dielectric layer 123, and a cladding sub-layer 434 may be formed to fill a recess on a portion of the cladding sub-layer 433. As such, a carrier 10 including an interconnection structure 10R integrated with an optical coupling structure 40 may be formed. Next, referring to FIG. 2A, electrical contacts 91 may be disposed over a lower surface 10b of the substrate 110, a photonic component 20 and an electronic component 30, may be disposed over the carrier 10, and an optical component 60 may be connected to the photonic component 20. In some arrangements, referring to FIG. 1, optical coupling structures 40, 40A, 40B, and 40C may be integrated with interconnection structures 10R, photonic components 20 and 20A and electronic components 30, 30A, 50, and 50A may be disposed over the carrier 10, and optical components 60 may be connected to the photonic components 20 and 20A, so as to form the electronic device 1 as illustrated in FIG. 1.

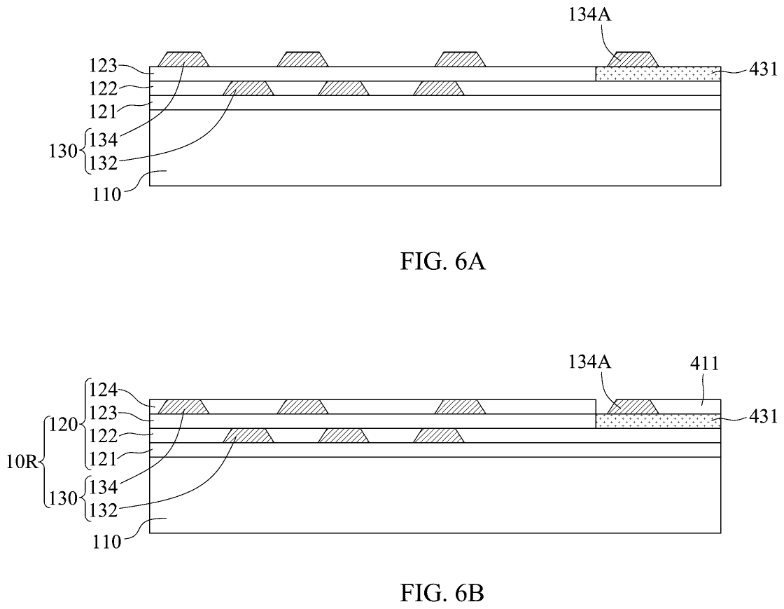

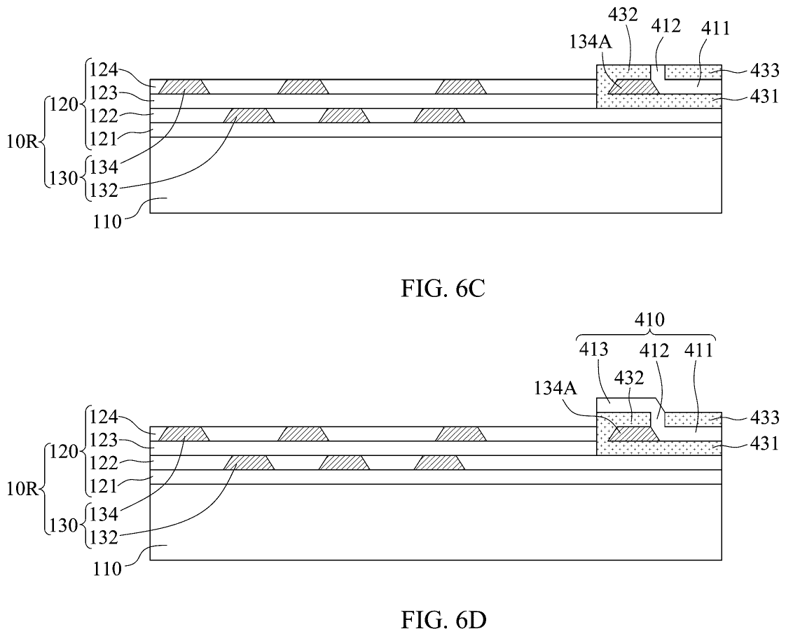

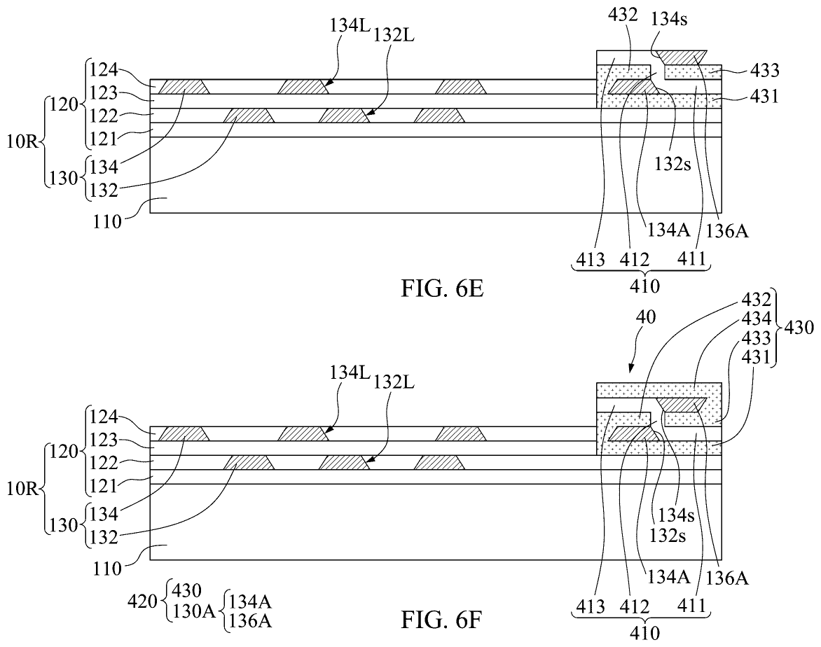

FIG. 6A, FIG. 6B, FIG. 6C, FIG. 6D, FIG. 6E, and FIG. 6F illustrate various stages of an example of a method for manufacturing an electronic device 1 in accordance with some arrangements of the present disclosure.

Referring to FIG. 6A, operations similar to those illustrated in FIGS. 5A-5C may be performed to provide a substrate 110 and form conductive traces 132, 134, and 134A, dielectric layers 121, 122, and 123, and a cladding sub-layer 431.

Referring to FIG. 6B, a dielectric layer 124 may be formed on the dielectric layer 123, and a waveguide 411 may be formed by coating a photoresist layer follower by photolithography.

Referring to FIG. 6C, operations similar to those illustrated in FIG. 5C may be performed to form a waveguide 412 and cladding sub-layers 432 and 433.

Referring to FIG. 6D, operations similar to those illustrated in FIG. 5D may be performed to form a waveguide 413.

Referring to FIG. 6E, operations similar to those illustrated in FIG. 5E may be performed to form a conductive trace 134A.

Referring to FIG. 6F, operations similar to those illustrated in FIG. 5F may be performed to form a cladding sub-layer 434. As such, a carrier 10 including an interconnection structure 10R integrated with an optical coupling structure 40 may be formed. Next, referring to FIG. 2C, electrical contacts 91 may be disposed over a lower surface 10b of the substrate 110, a photonic component 20 and an electronic component 30, may be disposed over the carrier 10, and an optical component 60 may be connected to the photonic component 20. In some arrangements, referring to FIG. 1, optical coupling structures 40, 40A, 40B, and 40C may be integrated with interconnection structures 10R, photonic components 20 and 20A and electronic components 30, 30A, 50, and 50A may be disposed over the carrier 10, and optical components 60 may be connected to the photonic components 20 and 20A, so as to form the electronic device 1 as illustrated in FIG. 1.

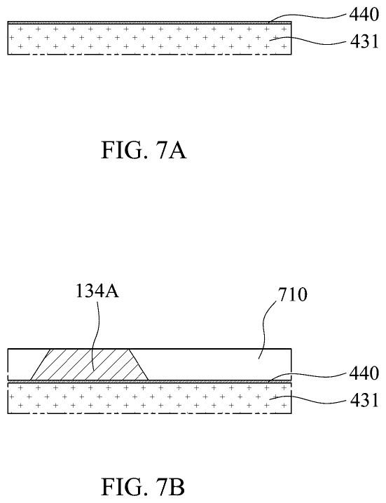

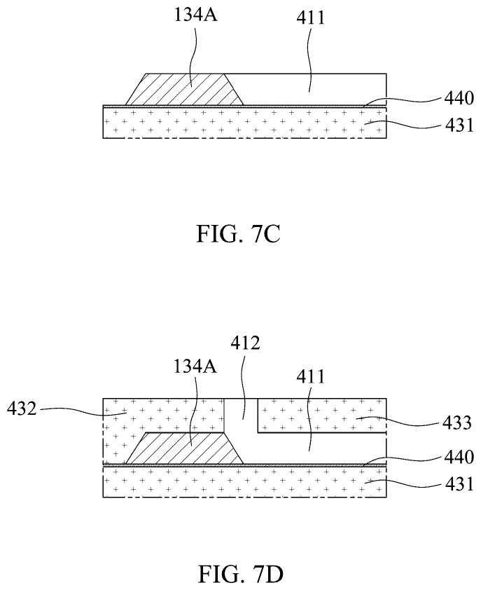

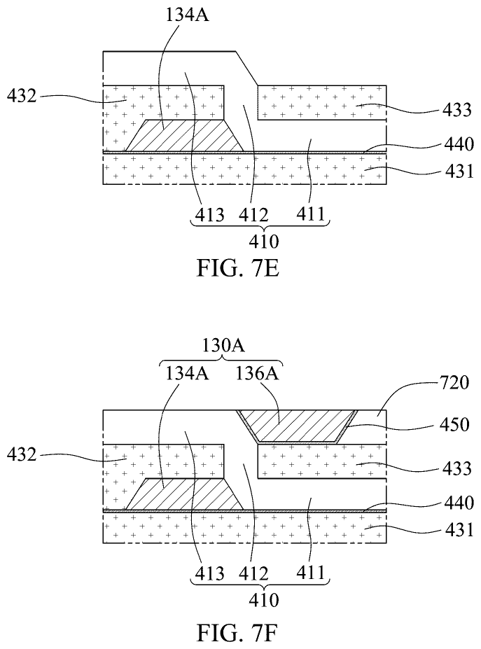

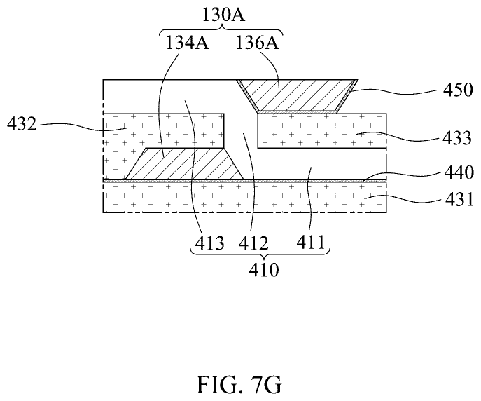

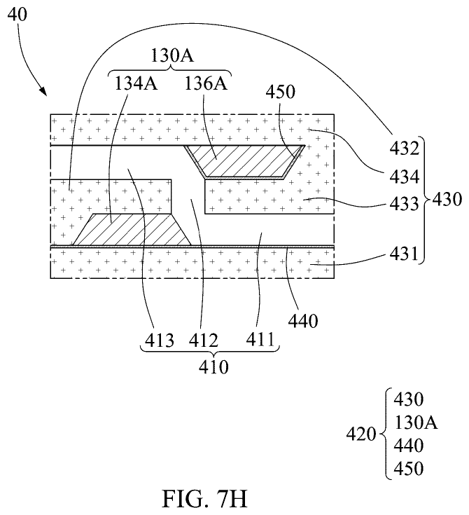

FIG. 7A, FIG. 7B, FIG. 7C, FIG. 7D, FIG. 7E, FIG. 7F, FIG. 7G, and FIG. 7H illustrate various stages of an example of a method for manufacturing an electronic device 1 in accordance with some arrangements of the present disclosure.

Referring to FIG. 7A and FIG. 6A, a seed layer 440 may be formed on the cladding sub-layer 431.

Referring to FIG. 7B and FIG. 6A, a photoresist layer 710 having a recess may be formed on the seed layer 440, and a conductive trace 134A may be formed on a portion of the seed layer 440 in the recess. In some arrangements, the conductive trace 134A is formed by plating.

Referring to FIG. 7C and FIG. 6B, the photoresist layer 710 may be removed, and operation similar to those illustrated in FIG. 6B may be performed to form a waveguide 411 on the seed layer 440.

Referring to FIG. 7D and FIG. 6C, a waveguide 412 may be formed on the waveguide 411, a cladding sub-layer 432 may be formed on a portion of the seed layer 440, and a cladding sub-layer 433 may be formed on the waveguide 411.

Referring to FIG. 7E and FIG. 6D, a waveguide 413 may be formed on the waveguide 412 and the cladding sub-layer 432.

Referring to FIG. 7F and FIG. 6E, a photoresist layer 720 may be formed to define a recess, a seed layer 450 may be formed on inner surfaces of the recess, and a conductive trace 136A may be formed on the seed layer 450 in the recess. In some arrangements, the conductive trace 136A may be formed by plating.

Referring to FIG. 7G, the photoresist layer 720 may be removed.

Referring to FIG. 7H and FIG. 6F, a cladding sub-layer 434 may be formed on the waveguide 413, the conductive trace 136A, the cladding sub-layer 433, and exposed surfaces of the seed layer 450. As such, the optical coupling structure 40 illustrated in FIG. 2D may be formed. In some arrangements, referring to FIG. 6F and FIG. 2D, the carrier 10 including an interconnection structure 10R integrated with an optical coupling structure 40 may be formed. Next, referring to FIG. 2C, electrical contacts 91 may be disposed over a lower surface 10b of the substrate 110, a photonic component 20 and an electronic component 30, may be disposed over the carrier 10, and an optical component 60 may be connected to the photonic component 20. In some arrangements, referring to FIG. 1, optical coupling structures 40, 40A, 40B, and 40C may be integrated with interconnection structures 10R, photonic components 20 and 20A and electronic components 30, 30A, 50, and 50A may be disposed over the carrier 10, and optical components 60 may be connected to the photonic components 20 and 20A, so as to form the electronic device 1 as illustrated in FIG. 1.

Spatial descriptions, such as “above,” “below,” “up,” “left,” “right,” “down,” “top,” “bottom,” “vertical,” “horizontal,” “side,” “higher,” “lower,” “upper,” “over,” “under,” and so forth, are indicated with respect to the orientation shown in the figures unless otherwise specified. It should be understood that the spatial descriptions used herein are for purposes of illustration only, and that practical implementations of the structures described herein can be spatially arranged in any orientation or manner, provided that the merits of embodiments of this disclosure are not deviated from by such an arrangement.

As used herein, the terms “approximately,” “substantially,” “substantial” and “about” are used to describe and account for small variations. When used in conjunction with an event or circumstance, the terms can refer to instances in which the event or circumstance occurs precisely as well as instances in which the event or circumstance occurs to a close approximation. For example, when used in conjunction with a numerical value, the terms can refer to a range of variation less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, a first numerical value can be deemed to be “substantially” the same or equal to a second numerical value if the first numerical value is within a range of variation of less than or equal to ±10% of the second numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, “substantially” perpendicular can refer to a range of angular variation relative to 90° that is less than or equal to ±10°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°.

Two surfaces can be deemed to be coplanar or substantially coplanar if a displacement between the two surfaces is no greater than 5 μm, no greater than 2 μm, no greater than 1 μm, or no greater than 0.5 μm. A surface can be deemed to be substantially flat if a displacement between a highest point and a lowest point of the surface is no greater than 5 μm, no greater than 2 μm, no greater than 1 μm, or no greater than 0.5 μm.

As used herein, the singular terms “a,” “an,” and “the” may include plural referents unless the context clearly dictates otherwise.

As used herein, the terms “conductive,” “electrically conductive” and “electrical conductivity” refer to an ability to transport an electric current. Electrically conductive materials typically indicate those materials that exhibit little or no opposition to the flow of an electric current. One measure of electrical conductivity is Siemens per meter (S/m). Typically, an electrically conductive material is one having a conductivity greater than approximately 104 S/m, such as at least 105 S/m or at least 106 S/m. The electrical conductivity of a material can sometimes vary with temperature. Unless otherwise specified, the electrical conductivity of a material is measured at room temperature.

Additionally, amounts, ratios, and other numerical values are sometimes presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified.

While the present disclosure has been described and illustrated with reference to specific embodiments thereof, these descriptions and illustrations are not limiting. It should be understood by those skilled in the art that various changes may be made and equivalents may be substituted without departing from the true spirit and scope of the present disclosure as defined by the appended claims. The illustrations may not be necessarily drawn to scale. There may be distinctions between the artistic renditions in the present disclosure and the actual apparatus due to manufacturing processes and tolerances. There may be other embodiments of the present disclosure which are not specifically illustrated. The specification and drawings are to be regarded as illustrative rather than restrictive. Modifications may be made to adapt a particular situation, material, composition of matter, method, or process to the objective, spirit and scope of the present disclosure. All such modifications are intended to be within the scope of the claims appended hereto. While the methods disclosed herein have been described with reference to particular operations performed in a particular order, it will be understood that these operations may be combined, sub-divided, or re-ordered to form an equivalent method without departing from the teachings of the present disclosure. Accordingly, unless specifically indicated herein, the order and grouping of the operations are not limitations of the present disclosure.

What is claimed is:

1. An electronic device, comprising:
a photonic component;
a waveguide structure configured to optically couple to the photonic component; and
a cladding structure comprising a first portion and a second portion comprising different materials and covering different regions of the waveguide structure.

2. The electronic device as claimed in claim 1, wherein the first portion comprises a plurality of conductive traces disposed at different elevations.

3. The electronic device as claimed in claim 2, wherein the waveguide structure comprises a plurality of waveguides contacting the plurality of conductive traces of the first portion of the cladding structure.

4. The electronic device as claimed in claim 3, wherein the plurality of waveguides further contact the second portion of the cladding structure.

5. The electronic device as claimed in claim 1, further comprising an optical component, wherein the waveguide structure is configured to optically couple the photonic component to the optical component.

6. The electronic device as claimed in claim 1, wherein the waveguide structure comprises a first waveguide and a second waveguide disposed at different elevations, and the first portion of the cladding structure comprises a first conductive trace contacting the first waveguide and a second conductive trace contacting the second waveguide.

7. The electronic device as claimed in claim 6, wherein the first conductive trace and the second conductive trace taper toward opposite directions.

8. The electronic device as claimed in claim 6, wherein the first conductive trace defines a reflective surface of the first waveguide, and the second conductive trace defines a reflective surface of the second waveguide.

9. The electronic device as claimed in claim 1, wherein the first portion and the second portion of the cladding structure contact the different regions of the waveguide structure.

10. An electronic device, comprising:
a first photonic component;
a carrier comprising a first conductive layer and a second conductive layer at different elevations and electrically connected to the first photonic component; and
an optical waveguide structure comprising a first waveguide and a second waveguide at different elevations and disposed adjacent to the first conductive layer and the second conductive layer, respectively.

11. The electronic device as claimed in claim 10, wherein the first conductive layer comprises a first conductive trace electrically connected to the first photonic component and a second conductive trace defining a slope of the first waveguide.

12. The electronic device as claimed in claim 11, wherein the first waveguide, the first conductive trace, and the second conductive trace are at a substantially same elevation.

13. The electronic device as claimed in claim 11, wherein the first conductive trace and the second conductive trace taper toward a substantially same direction.

14. The electronic device as claimed in claim 11, wherein the second conductive layer comprises a third conductive trace electrically connected to the first photonic component and a fourth conductive trace defining a slope of the second waveguide, the first conductive trace and the second conductive trace are at a first elevation, and the third conductive trace and the fourth conductive trace are at a second elevation higher than the first elevation with respect to a bottom surface of the carrier.

15. The electronic device as claimed in claim 14, wherein the first conductive trace and the second conductive trace taper toward a first direction, and the third conductive trace and the fourth conductive trace taper toward a second direction opposite to the first direction.

16. An electronic device, comprising:
a photonic component; and
an optical coupling structure configured to optically couple to the photonic component, wherein the optical coupling structure comprises a first waveguide and a second waveguide at different elevations and extending in non-parallel directions.

17. The electronic device as claimed in claim 16, wherein the optical coupling structure further comprises an optical via between and connecting to the first waveguide and the second waveguide.

18. The electronic device as claimed in claim 16, wherein the optical coupling structure
further comprises a cladding structure covering the first waveguide and the second waveguide, wherein the cladding structure comprises:
a first reflective element contacting a first chamfered surface of the first waveguide; and
a dielectric layer contacting the first waveguide and the first reflective element.

19. The electronic device as claimed in claim 18, wherein the cladding structure further comprises a second reflective element contacting a second chamfered surface of the second waveguide, and the dielectric layer further contacts the second waveguide and the second reflective element.

20. The electronic device as claimed in claim 16, wherein the optical coupling structure further comprises a third waveguide configured to optically couple to the second waveguide through the first waveguide, and the first waveguide and third waveguide are at different elevations and extending in non-parallel directions.
